(19) United States
(12) Patent Application Publication
(10) Pub. No.: US 2010/0185811 A1
(43) Pub. Date: Jul. 22, 2010

(54) Data processing system and method

(75) Inventor: Jin Hyoung Kwon, Seongnam-si (KR)

Correspondence Address: HARNESS, DICKEY & PIERCE, P.L.C., P.O. BOX 8910, RESTON, VA, 20195, US

(73) Assignee: Samsung Electronics Co., Ltd.

(21) Appl. No.: 12/654,845

(22) Filed: Jan. 6, 2010

(30) Foreign Application Priority Data
Jan. 21, 2009 (KR) 10-2009-0004933

(51) Int. Cl. G06F 12/00

(52) U.S. Cl. 711/105; 711/149; 711/E12.001

(57) ABSTRACT

A data processing system including a non-volatile memory and a processor controlling an operation of the non-volatile memory is provided. The processor transmits and receives a first type of data to and from an outside through a first path through which a first command and a first address, which are used to write/read the first data to/from the non-volatile memory, are transmitted. The processor also transmits and receives a second type of data to and from the outside through a second path different from the first path through which a second command and a second address, which are used to write/read the second data to/from the non-volatile memory, are transmitted.

### CROSS-REFERENCE TO RELATED APPLICATIONS

This application claims priority under 35 U.S.C. §119 to Korean Patent Application No. 10-2009-0004933, filed on 21 Jan. 2009, in the Korean Intellectual Property Office, the disclosure of which is incorporated herein by reference in its entirety.

### BACKGROUND

Example embodiments of the present invention relate to data processing technology, and more particularly, to a data processing system and method for accessing data through different paths according to types of data.

For a data processing system including a memory and a processor, technology for processing data between the memory and the processor at high speed is desired.

### SUMMARY

Some embodiments of the present invention provide an apparatus and method for processing data between a memory and a processor at high speed in a data processing system.

According to some embodiments of the present invention, there is provided a data processing system including a non-volatile memory and a processor configured to control an operation of the non-volatile memory. The processor transmits and receives a first type of data to and from an outside through a first path through which a first command and a first address, which are used to write/read the first data to/from the non-volatile memory, are transmitted. The processor also transmits and receives a second type of data to and from the outside through a second path different from the first path through which a second command and a second address, which are used to write/read the second data to/from the non-volatile memory, are transmitted.

The data processing system may further include a data storage device connected with the processor to process the second type of data. As an alternative, the data processing system may further include a multi-port memory device comprising a memory area, which is accessible via a first port connected with the processor or a second port connected with the outside and processes the second data.

As another alternative, the data processing system may further include a multi-port memory device including a first dedicated memory area accessible via a first port connected with the processor, a second dedicated memory area accessible via a second port connected with the outside, and a shared memory area, which is accessible via the first port or the second port according to an access authority and processes the second type of data. At this time, the second type of data may pass via the first dedicated memory area or the second dedicated memory area and may be processed in the shared memory area.

The size of the first type of data may be less than the size of the second type of data. The data rate of the first type of data may be lower than the data rate of the second type of data. The first type of data may be code data and the second type of data may be user data. The first type of data may be page size data and the second type of data may be user data having a larger size than the page size.

The data processing system may be a memory card or a solid state drive. The first path may include a card interface or a serial advanced technology architecture (SATA) interface and the second path may include a dynamic random access memory (DRAM) interface of a static random access memory (SRAM) interface. The first path may include a non-DRAM interface and the second path may include a DRAM interface. The first path may include a non-SRAM interface and the second path may include an SRAM interface.

According to other embodiments of the present invention, there is provided a data processing method including writing code data, input from an outside through a first path in a code data processing mode, to a non-volatile memory using a processor; and writing user data, input from the outside through a second path in a user data processing mode, to the non-volatile memory using the processor.

The data processing method may further include receiving a write command and a write address for the code data through the first path using the processor, before writing the code data to the non-volatile memory; and receiving a write command and a write address for the user data through the first path using the processor, before writing the user data to the non-volatile memory. A size of the code data may be less than a size of the user data. A data rate of the code data may be lower than a data rate of the user data.

According to further embodiments of the present invention, there is provided a data processing method including determining a type of an access data at a processor and accessing a non-volatile memory through a first path or through a second path having a higher data transmission speed than the first path depending on a determination result.

The accessing the non-volatile memory may include, when the access data is determined to be a first type of data, accessing the non-volatile memory through the first path, through which a command and an address for accessing the first type of data are transmitted, using the processor. The accessing the non-volatile memory may further include, when the access data is determined to be the second type of data having a larger size than the first data, accessing the non-volatile memory via a data storage device, which is located on the second path different from the first path through which a command and an address for accessing the second data are transmitted.

In other embodiments, a data processing system includes a data storage device configured to store input data and a first processor configured to determine a type of access data and transmit the access data to a second processor or the data storage device according to a determination result. The second processor is configured to write the access data output from the first processor or data output from the data storage device to a non-volatile memory. The first processor maybe configured to determine the type of the access data according to a size of the access data.

In yet other embodiments, a data processing system includes a first port, a second port, a first processor configured to be connected with the first port and to determine whether write data is a first type of data or a second type of data. A data storage device is connected between the first processor and the second port. When the write data is the first type of data, the first processor is configured to transmit the first type of data and a first command and a first address for writing the first type of data to the first port. When the write data is the second type of data, the first processor is configured to transmit a second command and a second address for writing the second type of data to the first port. The data storage device is configured to receive and process the second type of data and transmit the processed second type of data to the second port.

The data processing system may further include a second processor connected with the first port and the second port. The second processor is configured to write the first type of data input via the first port to a non-volatile memory according to the first command and the first address input via the first port. The second processor is also configured to write the second type of data input via the second port to the non-volatile memory according to the second command and the second address input via the first port.

In still other embodiments, a data processing method in a data processing system including a first port, a second port, a processor connected with the first port, and a data storage device connected between the processor and the second port includes determining whether write data is a first type of data or second type of data using the processor. When the write data is the first type of data, the method includes transmitting the first type of data and a first command and a first address for writing the first type of data to the first port using the processor. When the write data is the second type of data, the method includes transmitting a second command and a second address for writing the second type of data to the first port, transmitting the second type of data to the data storage device using the first processor; and the method further includes processing the received second type of data and transmitting the processed second type of data to the second port using the data storage device.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of a data processing system according to some embodiments of the present invention;

FIG. 2 is a block diagram of a data processing system according to other embodiments of the present invention;

FIG. 3 is a block diagram of a data storage device illustrated in FIG. 2;

FIG. 4 is a flowchart of a data processing method according to some embodiments of the present invention;

FIG. 5 is a block diagram of a data processing system according to further embodiments of the present invention;

FIG. 6 is a block diagram of a second processor illustrated in FIG. 5;

FIG. 7 is a block diagram for explaining the functions of a semaphore and a mail box included in a data storage device illustrated in FIG. 5;

FIG. 8 is a block diagram of the data storage device illustrated in FIG. 5;

FIG. 9 is a flowchart of the data write operation of the data processing system illustrated in FIG. 5;

FIG. 10 is a flowchart of the data read operation of the data processing system illustrated in FIG. 5;

FIG. 11 is a block diagram of a data processing system including a memory card according to some embodiments of the present invention;

FIG. 12 is a block diagram of a data processing system including a memory card according to other embodiments of the present invention;

FIG. 13 is a block diagram of a data processing system including a host and the memory card illustrated in FIG. 11;

FIG. 14 is a block diagram of a data processing system including a host and the memory card illustrated in FIG. 12; and

FIG. 15 is a block diagram of an electronic system including the memory card illustrated in FIG. 11 or 12.

### DETAILED DESCRIPTION OF THE EMBODIMENTS

The present invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. As used herein, the term “and/or” includes any and all combinations of one or more of the associated listed items and may be abbreviated as “/”.

It will be understood that, although the terms first, second, etc. may be used herein to describe various elements, these elements should not be limited by these terms. These terms are only used to distinguish one element from another. For example, a first signal could be termed a second signal, and, similarly, a second signal could be termed a first signal without departing from the teachings of the disclosure.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and/or the present application, and will not be interpreted in an idealized or overly formal sense unless expressly so defined herein.

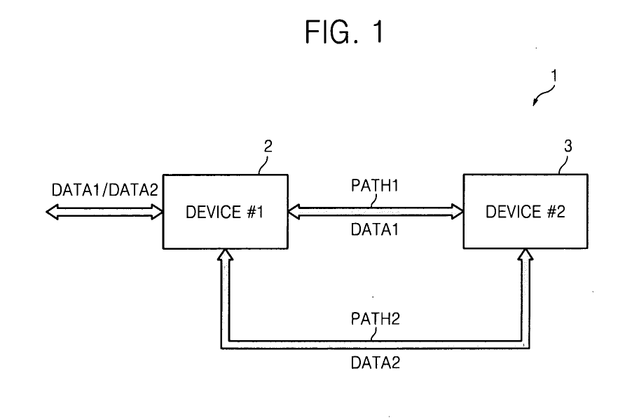

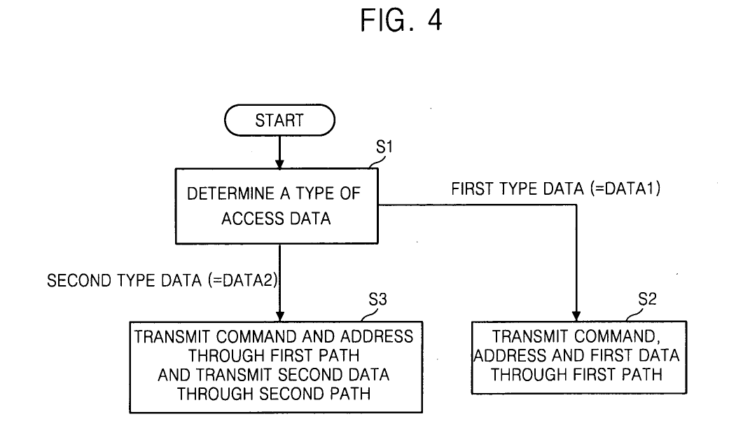

FIG. 1 is a block diagram of a data processing system 1 according to example embodiments of the present invention. FIG. 4 is a flowchart of a data processing method according to example embodiments of the present invention. Hereinafter a data processing system and its operation will be explained with reference to FIG. 1 and FIG. 4.

The data processing system 1 includes a plurality of devices 2 and 3. Each of the devices 2 and 3 denotes a device that can process, for example, data for write operation and/or read operation. For instance, each of the devices 2 and 3 may be a central processing unit (CPU) or a processor having a data storage area (or region). According to an embodiment, the first device 2 may be a host like a CPU and the second device 3 may include a non-volatile memory (not shown) that can store a first type of DATA1 or second type of DATA2 and a processing circuit (not shown) that can process (e.g., write or read) the a first type of DATA1 or the second type of DATA2.

Referring to FIG. 4, in a write operation, the first device 2 may receive externally input data that may be one of the first type of DATA1 and the second type of DATA2, and determine a type of the data (for example, at a file system level) in operation S1. If the data is determined as the first type of DATA1, the first device 2 transmits a command and an address for writing the first type of DATA1 to the second device 3 and transmits the first type of DATA1 to the second device 3 through a first path PATH1 in operation S2. On the other hand, if the first device 2 determines the received input data is the second type of DATA2 in operation S1, the first device 2 transmits a command and an address for writing the second type of DATA2 to the second device 3 through the first path PATH1 to the second device 3 and transmits the second type of DATA2 through a second path PATH2 to the second device 3 in operation S3.

The first path PATH1 may include at least one signal line to transmit the first type of DATA1 and the command and the address for writing the first type of DATA1 or to transmit the command and the address for writing the second type of DATA2. The second path PATH2 separated from the first path PATH1 may include at least one signal line to transmit the second type of DATA2. The size of the first type of DATA1 may be less than that of the second type of DATA2. The first type of DATA1 may be code data, update data for updating a program that has been stored in the second device 3, a communication code (e.g., base station information) transferred between a base station and a mobile communication terminal, or page size data. The page size may be 512 bytes, 1 Kbyte, 2 Kbytes, or 4 Kbytes. The second type of DATA2 may be user data such as image data or mass data.

Referring to FIG. 4, in a read operation, the first device 2 may determine a type of data (e.g., the first type of DATA1 or the second type of DATA2) to be read from the second device 3 in operation S1. If the type of data to be read is determined as the first type of DATA1 in operation S1, the first device 2 may transmit a command and an address for reading the first type of DATA1 to the second device 3 through the first path PATH1. Accordingly, the second device 3 storing the first type of DATA1 may transmit the first type of DATA1 to the first device 2 through the first path PATH1 in operation S2. After that, the first device 2 may process the first type of DATA1 or transmit the first type of DATA1 to an outside apparatus.

On the other hand, if the type of data to be read is determined as the second type of DATA2 in operation S1, (1) the first device 2 may transmit a command and an address for reading the second type of DATA2 to the second device 3 through the first path PATH1 and (2) the second device 3 storing the second type of DATA2 may transmit the second type of DATA2 to the first device 2 through the second path PATH2 in operation S3. After that, the first device 2 may process the second type of DATA2 or transmit the second type of DATA2 to an outside apparatus.

The first device 2 may determine a type of data according to the size of the data being accessed and transmit the accessed data to the second device 3 through the first path PATH1 or the second path PATH2 for write operation depending on the determination result. The second device 3 may determine a type of data being accessed according to a command input from the first device 2 and transmit the accessed data to the first device 2 through the first path PATH1 or the second path PATH2 for read operation depending on a determination result. A data processing speed through the first path PATH1 may be different from a data processing speed through the second path PATH2. For instance, the data processing speed through the first path PATH1 may be lower than the data processing speed through the second path PATH2.

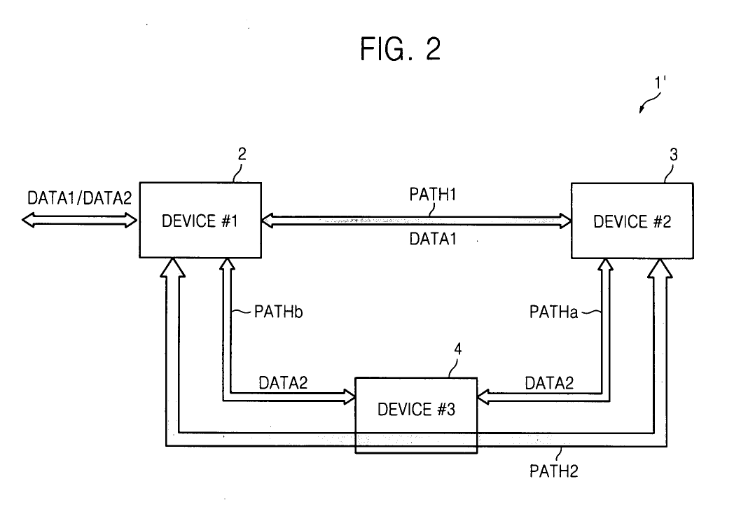

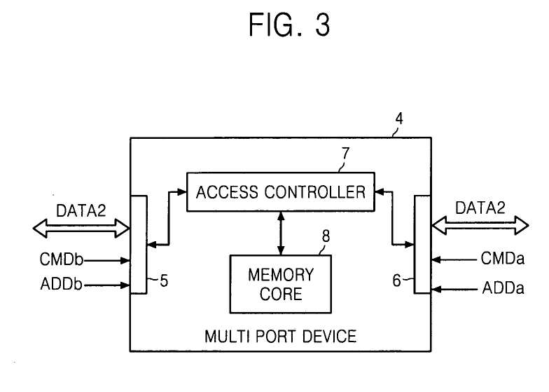

FIG. 2 is a block diagram of a data processing system 1′ according to other example embodiments of the present invention. FIG. 3 is a block diagram of a data storage device illustrated in FIG. 2. Hereinafter a data processing system 1′ and its operation will be explained with reference to FIG. 2 through FIG. 4.

The data processing system 1′, illustrated in FIG. 2 may include a plurality of devices 2, 3, and 4. The devices 2 and 3 connected to each other through a first path PATH1 denote devices that can process, for example, data for write operation and/or read operation. For instance, each of the first and second devices 2 and 3 may be a CPU or a processor having a data storage area (region). The third device 4 may be connected between the device 2 and the device 3 through a second portion PATHb of a second path PATH2 and a first portion PATHa of a second path PATH2, respectively. The PATHb and PATHa may form like PATH2 of FIG. 1.

Referring to FIG. 3, the third device 4 may be a data storage device that may be a buffer memory or a multi-port memory including a plurality of ports 5 and 6. Each of the first and second devices 2 and 3 may exclusively access a memory core 8 of the third device 4 depending on an access authority. Also, the data storage device 4 may be one of a non-volatile memory and a volatile memory. The third device 4 may include a second port 5, a first port 6, an access controller 7 and memory core 8. The second port 5 interfaces the second type of DATA2 with the first device 2 and receives a second command CMDb from the first device 2. The first port 5 interfaces the second type of DATA2 with the second device 3 and receives a first command CMDa from the second device 3. The access controller 7 may control an accessibility of each of the ports to the memory core 8 in response to each of the second command CMDb and the first command CMDa.

Referring to FIGS. 2 through 4, in a write operation, the first device 2 may receive externally input data that may include one of the first type of DATA1 and the second type of DATA2, and determine a type of the data in operation S1. If the input data is determined as the first type of DATA1, the first device 2 transmits a command and an address for writing the first type of DATA1 to the second device 3 and the first type of DATA1 to the second device 3 through a first path PATH1 in operation S2. On the other hand, if the input data is determined as the second type of DATA2, the in step S3 the first device 2 may transmit a command and an address for writing the second type of DATA2 to the second device 3 through the first path PATH1. At this time, the first device 2 may transmit the second command CMDb, including a command and an address for writing the second type of DATA2 to the third device 4 and the second type of DATA2 to the third device 4 through the second portion PATHb of a second path PATH2 in operation S3 according to the determination result.

The second type of DATA2 input to the third device 4 via the second port 5 is stored in the memory core 8 in response to the second command CMDb under the control of an access controller 7.

The second device 3 may transmit the first command CMDa and address to the first port 6 of the third device 4 according to the command and the address for writing the second type of DATA2 received through the first path PATH1. For example, the first command CMDa and address may be the same as the command and address received from the first device 2; and the first command CMDa and address maybe the opposite of the second command CMDb, but the same address, as sent to the third device 3 from the first device 2. The access controller 7 may transmit the second type of DATA2 written to the memory core 8 to the second device 3 through the first portion PATHa of the second path PATH2 in response to the first command CMDa input from the second device 3. Therefore, the second type of DATA2 output from the first device 2 may be transmitted to the second device 3 through the second path PATH2 including the path portions PATHb and PATHa.

Referring again to FIG. 4, in a read operation, the first device 2 may determine a type of data (e.g., the first type of DATA1 or the second type of DATA2) to be read from the second device 3 in operation S1. If the read data is determined as the first type of DATA1, the first device 2 may transmit a command and an address for reading the first type of DATA1 to the second device 3 through the first path PATH1. Accordingly, the second device 3 storing the first type of DATA1 may transmit the first type of DATA1 to the first device 2 through the first path PATH1 according to the command and the address in operation S2. At this time, the first device 2 may process the first type of DATA1 or transmit the first type of DATA1 to an outside apparatus.

On the other hand, if the read data from the second device 3 is determined as the second type of DATA2 in operation S1, the first device 2 may transmit a command and an address for reading the second type of DATA2 to the second device 3 through the first path PATH1. The second device 3 storing the second type of DATA2 may transmit a first command CMDa and address based on the command and address from the first device 2 (e.g., the same command and address) along with the second type of DATA2 to the first port 6 of the third device 4 through the first portion PATHa of the second path PATH2 in operation S3.

The access controller 7 writes the second type of DATA2 to the memory core 8 in response to the first command CMDa and address input from the second device 3. After the writing of the second type of DATA2 is completed, in response to the second command CMDb input from the first device 2, the first device 2 transmits the second command CMDb and address for reading the second type of DATA2 written into the memory core 8 of the third device 4 to the second port 5. The second command CMDb and address may be the same as the command and address sent to the second device 3; and maybe the opposite of the first command CMDa, but the same address, as sent to the third device 3 from the first device 2. The access controller 7 may read the second type of DATA2 written to the memory core 8 and transmit the second type of DATA2 to the first device 2 through the second portion PATHb of the second path PATH2 in response to the second command CMDb and address. Therefore, the second type of DATA2 output from the second device 3 may be transmitted to the first device 2 through the second path PATH2. The access controller 7 decodes the first command CMDa and/or the second command CMDb and controls the memory core 8 so that the first device 2 or the second device 3 can access the memory core 8 according to a decoding result. Each of the first and second commands CMDa and CMDb may include a write/read command and is accompanied by a write/read address. However, the commands could, alternatively, includes the addresses. The third device 4 may be a buffer memory that can buffer the second type of DATA2 or a memory that can temporarily store the second type of DATA2.

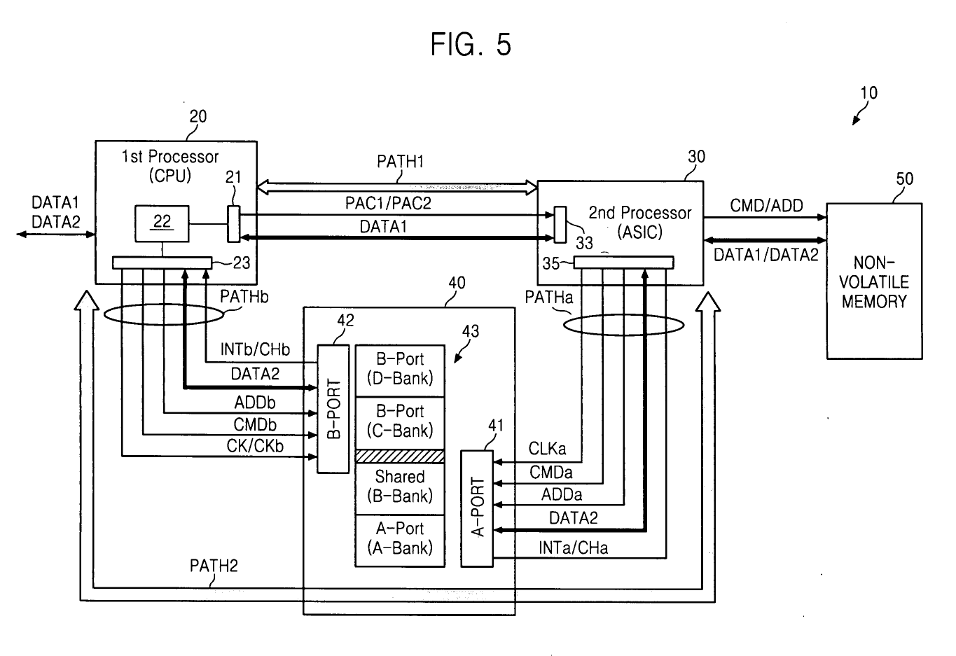

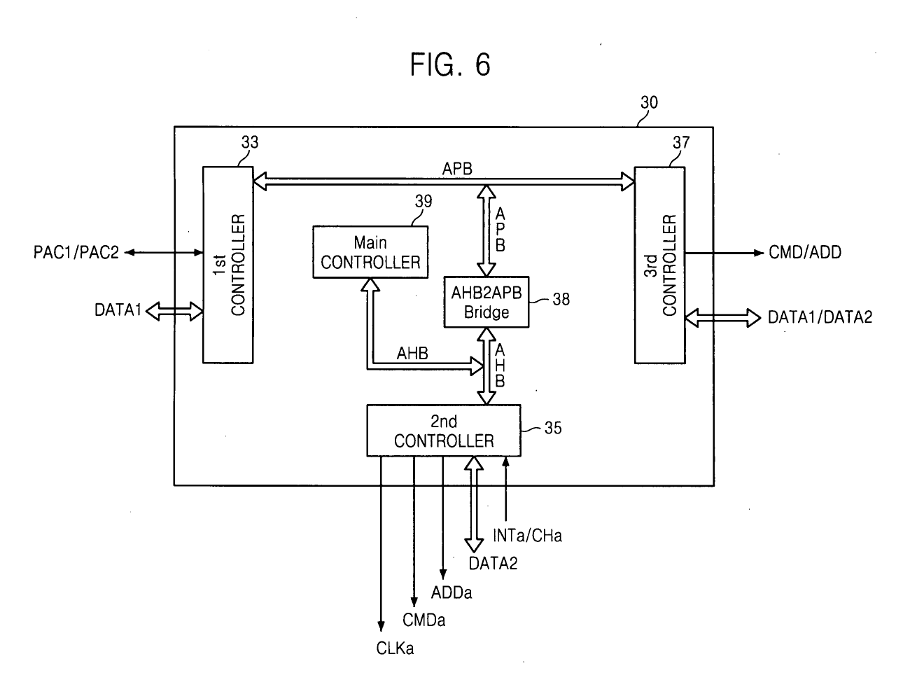

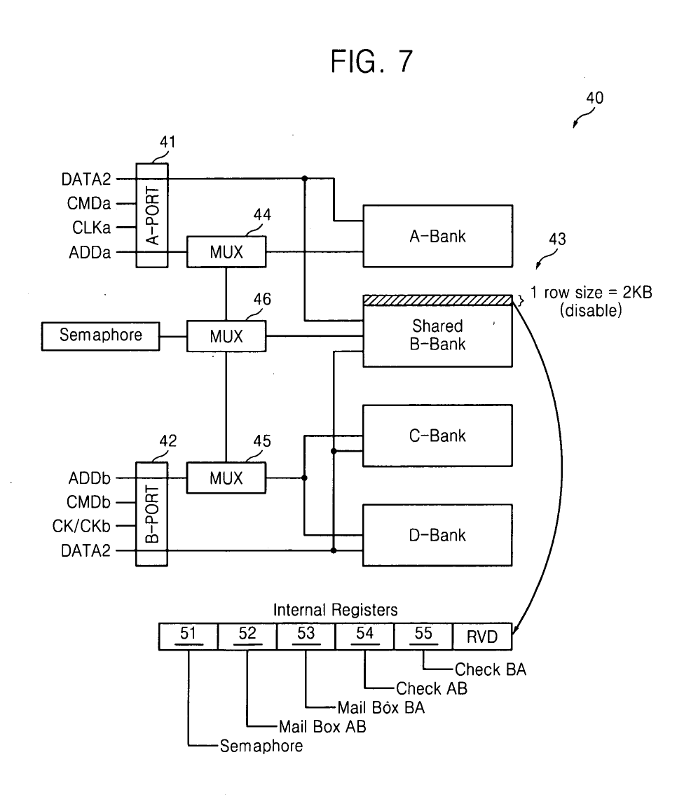

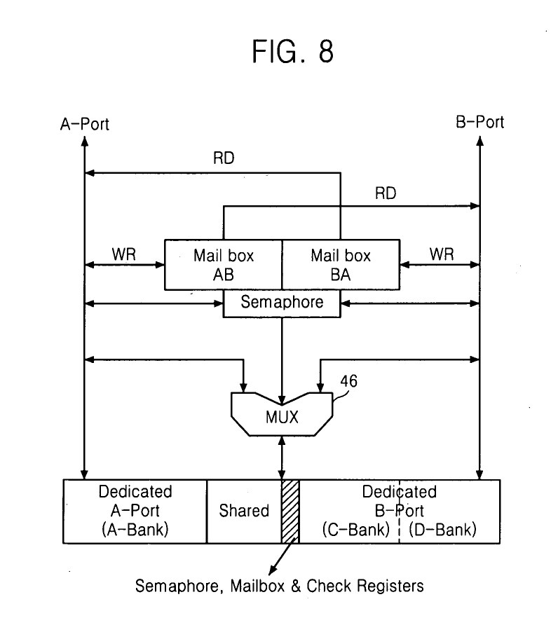

FIG. 5 is a block diagram of a data processing system 10 according to further example embodiments of the present invention. FIG. 6 is a block diagram of the second processor 30 illustrated in FIG. 5. FIG. 7 is a block diagram for explaining the functions of a semaphore and a mail box included in the data storage device 40 illustrated in FIG. 5. FIG. 8 is a block diagram of the data storage device 40 illustrated in FIG. 5. Hereinafter a data processing system and its operation according to example embodiments of this invention will be explained with reference to FIG. 5 through FIG. 8

According to example embodiments, when the data processing system 10 is implemented using a memory card (e.g., a secure digital (SD) card or a multimedia card (MMC)), the memory card may include the second processor 30 and the non-volatile memory 50. Alternatively, the memory card may include the second processor 30, the data storage device 40, and the non-volatile memory 50.

The second processor 30 and the non-volatile memory 50 or the second processor 30, the data storage device 40 and the non-volatile memory 50 may be implemented in a package such as a package on package (PoP), a ball grid array (BGA), a chip scale package (CSP), a plastic leaded chip carrier (PLCC), a plastic dual in-line package (PDIP), a die in waffle pack, a die in wafer form, a chip on board (COB), a ceramic dual in-line package (CERDIP), a plastic metric quad flat pack (MQFP), a thin quad flat pack (TQFP), a small outline integrated circuit (SOIC), a shrink small outline package (SSOP), a thin small outline package (TSOP), a system in package (SIP), a multi-chip package (MCP), a wafer-level fabricated package (WFP), or a wafer-level processed stack package (WSP).

Referring to FIG. 5, the data processing system 10 may include a first processor 20, a second processor 30, a data storage device 40, and a non-volatile memory 50. The first processor 20, the second processor 30 and the data storage device 40 correspond to the first device 2, the second device 3 and the third device 4 of FIG. 2, respectively. That is the processor 20 and the second processor 30 may be connected using a first path PATH1 and the first processor 20 and the second processor 30 may be connected using a second path PATH2 through the data storage device 40.

The first processor 20 may include a fourth interface 21 and a fifth interface 23. The fourth interface 21 interfaces the first processor 20 with the second processor 30 to communicate a first packet PAC1, a second packet PAC2, or the first type of DATA1 there between. The fifth interface 23 interfaces the first processor 20 with the data storage device 40 to communicate the second type of DATA2 there between. The first processor 20 may check or change a value of a semaphore register in the data storage device 40 indicating an access authority to access a shared memory bank or region of the data storage device 40 such as a multi-port memory device. This will be described in detail with reference to FIGS. 7 and 8 later.

The first processor 20 may also include a control logic (not shown) that controls the operation of the fourth interface 21 and the operation of the fifth interface 23. In addition, the first processor 20 may also include a functional block 22 that determines a type of data being accessed and generates a command and an address for processing the accessed data according to a determination result. The functional block 22 may be implemented in hardware or a recording medium embedded with software or firmware.

The first processor 20 may determine a type of access data DATA1 or DATA2, e.g., write data or read data, and select a path PATH1 or PATH2 for transmitting or receiving the access data DATA1 or DATA2 according to a determination result. For instance, the first processor 20, which may be implemented by a CPU, may determine the type of the access data DATA1 or DATA2 at a file system level.

The second processor 30 may include a first interface 33, a second interface 35 and a third interface 37. The first interface 33 may form a first path PATH1 interfacing the first packet PAC1, the second packet PAC2, or the first type of DATA1 with the fourth interface 21 of the first processor 20. The second interface 34 may form a first portion PATHa of the second path PATH2 interfacing control signals including a first command CMDa and the second type of data DATA2 with a first port of the data storage device 40. The third interface 37 interfaces control signals CMD/ADD including commands and addresses with a non-volatile memory 50.

The data storage device 40 may include a first port 41, a second port 42 and a plurality of memory banks 43. The first port 41 interfaces control signals including a first command CMDa and the second type of data DATA2 with the second interface 35, and the second port 42 interfaces a control signals including a second command CMDb and the second type of data DATA2 with the fifth interface 23. The plurality of memory banks 43 includes memory bank A dedicated to the first port 41, memory banks C and D dedicated to the second port 42 and a shared memory bank B that can be accessed by either the first port or the second port according to which port has an access authority. Also the data storage device 40 includes internal registers including a semaphore register, which stores information about the access authority. How the access authority is managed using the internal registers will be described later.

When the first interface 33 of the second processor 30 connected with the fourth interface 21 to form or set a first path PATH1 is a memory card interface, e.g., an SD card interface or an MMC interface, the fourth interface 21 may also be a memory card interface, e.g., an SD card interface or an MMC interface. When the first interface 33 of the second processor 30 connected with the fourth interface 21 is a serial advanced technology architecture (SATA) interface or a parallel advanced technology architecture (PATA) interface, the fourth interface 21 may also be a SATA or PATA interface. When a second port 42 of the data storage device 40 connected with the fifth interface 23 to form or set a second portion PATHb of a second path PATH2 is a dynamic random access memory (DRAM) or static random access memory (SRAM) interface, the fifth interface 23 may also be a DRAM or SRAM interface.

As mentioned above, the first type of DATA1 may be data, e.g., code data, having a smaller size than the second type of DATA2. The second type of DATA2 may be user data or mass data, e.g., graphic data, having a larger size than the first type of DATA1. A data rate of the first type of DATA1 may be different from a data rate of the second type of DATA2. According to example embodiments of the present invention, the data rate of the first type of DATA1 transmitted according to an SD card protocol, an MMC protocol, a SATA protocol, or a PATA protocol may be lower than the data rate of the second type of DATA2 transmitted according to a DRAM/SRAM protocol. Also, the first type of data may be page size data and the second type of data may be user data having a larger size than the page size. However, since the access data is separately processed through a different path, e.g., the first path PATH1 or the second path PATH2, according to the type of the access data, embodiments of the present invention are not restricted by the relative size of the access data. A case where the first processor 20 performs a write operation according to a type of access data will be described with reference to FIG. 5. The first processor 20 may determine externally input write data as the first type of DATA1 or the second type of DATA2 at a file system level. For example, in this and the other embodiments, the first device 2 may determines a type of an access data based on a reference data size. The reference data size, for example, 2 Kbyte is set or programmed by a vender in the first device 2. When the size of access data is equal to or less than the reference size, the access determined to be the first type of data. When the size of access data is greater than the reference size, the access data is determined to be the second type of data DATA2.

Case of Write Operation of the First Type of Data

If the write data is determined as the first type of DATA1, the first processor 20 may generate the first packet PAC1. An example structure of the first packet PAC1 is:

WRITE PACKET STRUCTURE

| | | | | |
|---|---|---|---|---|
| Write | Size of write | Path | Shared-Bank | Write |
| address | data | Information | address (only | command |
| | | | using a second | |
| | | | path) | |

As shown, the first packet PAC1 includes the write address of the non-volatile memory 50, the size of the data being written, path information, a shared bank address ADD (if applicable), and the write command. The write command indicates that data should be written into the non-volatile memory 50 starting from the write address. The path information indicates whether the first packet PAC1 should be sent on the first path PATH1 or the second path PATH2. For example, if set to a “1,” the path information indicates the first path PATH1; and if set to a “0”, the path information indicates the second path PATH2. Here, because the access data is of the first type, the path information will be set to “1.” Also, because the first packet will be transmitted over the first path PATH1, the first packet PAC1 does not include a shared-bank address, which would indicate the address of the shared bank in the data storage device 40. The first processor 20 transmits the first packet PAC1 to the second processor 30 through the first path PATH1. In addition, the first processor 20 may transmit the first type of DATA1 to the second processor 30 through the first path PATH1. Afterwards, the second processor 30 may write the first type of DATA1 to the non-volatile memory 50 in response to the first packet PAC1. Namely, in accordance with the write command, the second processor 30 writes the first type of data DATA1 in the non-volatile memory starting at the write address.

Case of Write Operation of the Second Type of Data

If the write data is determined as the second type of DATA2, the first processor 20 may generate the second packet PAC2, which has the same format as the first packet PAC1. However, in the second packet PAC2, the path information is set to “0” to indicate transport via the second path PATH2. Also, the second packet PAC2 will include a shared bank address ADD indicating an address in the shared memory bank B-Bank of the storage device in which to store the second type of data DATA2. The first processor 20 may transmit the second type of DATA2 and the second packet PAC2 through the second portion PATHb of the second path PATH2. Alternatively, the first processor 20 may only send the write command, the shared bank address, and the second type of data DATA2 to the storage device 40 for storing the second type of data in the shared memory bank B-Bank.

The first processor 20 may transmit the second packet PAC2 to the second processor 30 through the first path PATH1 while or after writing the second type of DATA2 to the shared memory bank B-Bank of the data storage device 40 through the second portion PATHb of the second path PATH2. Alternatively, the first processor 20 may transmit the second packet PAC2 to the second processor 30 through the first path PATH1 before transmitting the second type of DATA2 to the second portion PATHb of the second path PATH2. In this way, the first processor 20 can adjust transmission time points of the second packet PAC2 and the second type of DATA2.

As illustrated in FIG. 5, when the write data is the first type of DATA1, the first processor 20 may transmit the first packet PAC1 and the first type of DATA1 to the second processor 30 through the first path PATH1. However, when the write data is the second type of DATA2, the first processor 20 may transmit the second packet PAC2 to the second processor 30 through the first path PATH1 and may transmit the second type of DATA2 to the shared memory bank B-Bank of the data storage device 40 through the second portion PATHb of the second path PATH2 controlled and operating independently of the first path PATH1.

The second processor 30 may decode/parse the second packet PAC2. According to a decoding/parsing result, the second processor 30 may read the second type of DATA2 written to the shared memory bank B-Bank of the data storage device 40 through the first portion PATHa of the second path PATH2 using the shared bank address in the second packet PAC2, and the second processor 30 may write the second type of DATA2 to the non-volatile memory 50 at the write address indicated by the second packet PAC2.

As described above, the first processor 20 may directly write the second type of DATA2 to the shared memory bank B-Bank via the second port 42. Alternatively, the first processor 20 may write the second type of DATA2 to a dedicated memory bank C-Bank or D-Bank for the first processor 20 via the second port 42, then read the second type of DATA2 from the dedicated memory bank C-Bank or D-Bank, and then write the second type of DATA2 to the shared memory bank B-Bank. At this time, the first processor 20 may perform error correction on the second type of DATA2, and therefore, the reliability of the second type of DATA2 may be higher than when the second type of DATA2 is directly written to the shared memory bank B-Bank.

When the first processor 20 has the access authority over the shared memory bank B-Bank, the first processor 20 may write the second type of DATA2 to the shared memory bank B-Bank through the second portion PATHb of the second path PATH2. The management of access authority will be described in greater detail below. However, when the second processor 30 has the access authority over the shared memory bank B-Bank, the first processor 20 may request the second processor 30 to transfer the access authority over the shared memory bank B-Bank. After the access authority over the shared memory bank B-Bank is transferred from the second processor 30 to the first processor 20 in response to the request, the first processor 20 may write the second type of DATA2 to the shared memory bank B-Bank through the second portion PATHb of the second path PATH2.

A case where the first processor 20 performs a read operation according to a type of access data will be described with reference to FIG. 5. The first processor 20 may determine read data to be read as the first type of DATA1 or the second type of DATA2 at a functional block, e.g., a file system level.

Read Operation of the First Type of Data

If the read data is determined as the first type of DATA1, the first processor 20 may generate the first packet PAC1. An example structure of the first packet PAC1 is:

READ PACKET STRUCTURE

| | | | | |
|---|---|---|---|---|
| Read | Size of read | Path | Shared-Bank | Read |
| address | data | Information | address (only | command |
| | | | using a second | |
| | | | path) | |

As shown, the first packet PAC1 includes the read address of the non-volatile memory 50, the size of the data being read, path information, a shared bank address (if applicable) ADD, and the read command. The read command indicates that data should be read from the non-volatile memory 50 starting from the read address. The path information indicates whether the first packet PAC1 should be sent on the first path PATH1 or the second path PATH2. For example, if set to a “1,” the path information indicates the first path PATH1; and if set to a “0”, the path information indicates the second path PATH2. Here, because the access data is of the first type, the path information will be set to “1.” Also, because the first packet will be transmitted over the first path PATH1, the first packet PAC1 does not include a shared-bank address, which would indicate the address of the shared bank in the data storage device 40. The first processor 20 transmits the first packet PAC1 to the second processor 30 through the first path PATH1. The second processor 30 may read the first type of DATA1 from the non-volatile memory 50 according to a result of decoding/parsing the first packet PAC1 and may transmit the first type of DATA1 to the first processor 20 through the first path PATH1.

Read Operation of the Second Type of Data

If the read data is the second type of DATA2, the first processor 20 may generate the second packet PAC2 and transmit the second packet PAC2 to the second processor 30 through the first path PATH1. Here, the second packet PAC2 has the same format as the first packet PAC1. However, in the second packet PAC2, the path information is set to “0” to indicate transport via the second path PATH2. Also, the second packet PAC2 will include a shared bank address ADD indicating an address in the shared memory bank B-Bank of the storage device in which to store the read second type of data DATA2. According to a result of decoding the second packet PAC2, the second processor 30 may read the second type of DATA2 from the non-volatile memory 50 using the read address and the amount of data to be read, and then the second processor 30 may write the second type of DATA2 to the shared memory bank B-Bank of the data storage device 40 through the first portion PATHa of the second path PATH2 according to the shared bank address.

When the second processor 30 has the access authority over the shared memory bank B-Bank, the second processor 30 may write the second type of DATA2 to the shared memory bank B-Bank of the data storage device 40 through the first portion PATHa of the second path PATH2. When the second type of DATA2 is completely written to the shared memory bank B-Bank of the data storage device 40, the first processor 20 may read the second type of DATA2 from the shared memory bank B-Bank of the data storage device 40 through the second portion PATHb of the second path PATH2.

When the first processor 20 has the access authority over the shared memory bank B-Bank, the first processor 20 may read the second type of DATA2 from the shared memory bank B-Bank through the second portion PATHb of the second path PATH2. However, when the second processor 30 has the access authority over the shared memory bank B-Bank, the first processor 20 may request the second processor 30 to transfer the access authority. After the access authority over the shared memory bank B-Bank is transferred from the second processor 30 to the first processor 20 in response to the request, the first processor 20 may read the second type of DATA2 from the shared memory bank B-Bank through the second portion PATHb of the second path PATH2. Also, the management of access authority over the shared memory bank B-BANK will be described in greater detail below.

FIG. 6 is a block diagram of the second processor 30 illustrated in FIG. 5. Referring to FIGS. 5 and 6, the second processor 30 may include a first interface 33, a second interface 35, a third interface 37, a bridge 38, and a main controller 39 and be implemented by an application specific integrated circuit (ASIC). The first interface 33, the third interface 37, and the bridge 38 may transmit and receive data through a first bus, e.g., and advanced peripheral bus (APB). The second interface 35, the bridge 38, and the main controller 39 may transmit and receive data through a second bus, e.g., an advanced microcontroller bus architecture (AMBA) high-speed bus (AHB).

The first interface 33 is connected with the fourth interface 21 of the first processor 20 to function as a controller for transmitting and receiving the first type of DATA1. The first interface 33 may transmit the first packet PAC1, the second packet PAC2, or the first type of DATA1 input through the first path PATH1 to the bridge 38 through the first bus APB. The bridge 38 may convert a format of the first packet PAC1 or the second packet PAC2 and then transmit the first packet PAC1 or the second packet PAC2 to the main controller 39.

When the second processor 30 is implemented or embedded in a memory card, the first interface 33 may have a memory card interface, e.g., an SD card interface or an MMC interface. Accordingly, the first interface 33 may generate signals according to an SD card protocol or MMC protocol. When the second processor 30 is implemented or embedded in a solid state drive (SSD), the first interface 33 may have a SATA interface or PATA interface.

The second interface 35 is connected with a first port 41 of the data storage device 40 to function as an controller which transmits and/or receives the second type of DATA2 and control signals including a clock signal CLKa, the first command CMDa, a bank address ADDa, a first interrupt signal INTa, and a first check signal CHa. The indication of those signals are will be described in greater detail below with reference to FIGS. 7 and 8. The second interface 35 may perform interfacing to transmit and receive the second type of DATA2 to and from the first port 41. The second interface 35 may have a DRAM interface or SRAM interface.

The third interface 37 is connected with the non-volatile memory 50 to function as a controller for controlling the write or read operation of the non-volatile memory 50. Accordingly, when the non-volatile memory 50 is implemented by a flash memory, e.g., a NAND flash memory or a NOR flash memory, the third interface 37 may be a flash controller, e.g., a NAND flash controller or a NOR flash controller. When the non-volatile memory 50 is implemented by a universal memory, e.g., magnetic RAM (MRAM), ferroelectric RAM (FeRAM), resistive RAM (ReRAM), or a phase-change RAM (PRAM), the third interface 37 may have a structure meeting the type of the non-volatile memory 50.

The main controller 39 may decode/parse the first packet PAC1 or the second packet PAC2 input through the first path PATH1 and the bridge 38 and control the operation of at least one among the first interface 33, the second interface 35, and the third interface 37 according to a decoding result. The main controller 39 may function as a microprocessor for controlling the overall operation of the second processor 30. For instance, the main controller 39 may decode the first packet PAC1 input through the first path PATH1 and the bridge 38 and generate various control signals including a clock signal, a command CMD, and an address ADD for controlling the operation of the third interface 37.

Accordingly, in a write operation, the third interface 37 may write the first type of DATA1 input through the first path PATH1 to the non-volatile memory 50 under the control of the main controller 39 or independently of the operation of the main controller 39. In a read operation, the third interface 37 may read the first type of DATA1 from the non-volatile memory 50 and transmit the first type of DATA1 to the first controller 33 under the control of the main controller 39 or independently of the operation of the main controller 39. Then, the first interface 33 may transmit and receive the first type of DATA1 to and from the first processor 20 through the first path PATH1 independently of or under the control of the main controller 39.

The main controller 39 may also decode the second packet PAC2 input through the first interface 33 and the bridge 38 and generate various control signals for controlling the operation of the second interface 35 and the third interface 37 according to a decoding result. Accordingly, in a write operation, the second interface 35 may read the second type of DATA2 through the data storage device 40 on the second portion PATHb of the second path PATH2 and the third interface 37 may write the second type of DATA2 input through the second interface 35 to the non-volatile memory 50 under the control of the main controller 39 or independently of the operation of the main controller 39. In a read operation, the third interface 37 may read the second type of DATA2 from the non-volatile memory 50 and transmit the second type of DATA2 to the second interface 35 under the control of the main controller 39 or independently of the operation of the main controller 39. Then, the second interface 35 may write the second type of DATA2 read from the non-volatile memory 50 to the shared memory bank B-Bank of the data storage device 40.

When the second processor 30 has the access authority over the shared memory bank B-Bank, the second processor 30 may access the shared memory bank B-Bank through the first portion PATHa of the second path PATH2. However, when the first processor 20 has the access authority over the shared memory bank B-Bank, the second processor 30 may request the first processor 20 to transfer the access authority. After the access authority over the shared memory bank B-Bank is transferred from the first processor 20 to the second processor 30 in response to the request, the second processor 30 may access the shared memory bank B-Bank through the first portion PATHa of the second path PATH2. The transfer of the access authority over access the shared memory bank B-Bank will be described in detail with reference to FIGS. 7-8.

FIG. 7 is a detail block diagram of the data storage device 40 illustrated in FIG. 5. FIG. 8 is a block diagram for explaining the functions of a semaphore and a mail box included in the data storage device 40 illustrated in FIG. 5. Referring to FIGS. 5 through 8, the data storage device 40 may be implemented by a multi-port memory device. The data storage device 40 may process (e.g., write, read, or buffer) the second type of DATA2 using a data storage area, e.g., the shared memory bank B-Bank.

The multi-port memory device 40 may include the first port 41, the second port 42, at least one dedicated memory bank A-Bank that can be accessed by the first port 41, at least one dedicated memory bank C-Bank and/or D-Bank that can be accessed by the second port 42, and the shared memory bank B-Bank that can be accessed by the first port 41 or the second port 42 according to the access authority. The first port 41 and the second port 42 may be controlled and may operate independently. The first port 41 and the second port 42 may function as an interface or a controller.

For instance, the first port 41 may interface with the second controller 35 of the second processor 30 to transmit and/or receive the second type of DATA2 and the control signals CLKa, CMDa, ADDa, the first interrupt signal INTa, and the first check signal CHa for input/output of the second type of DATA2 through the first portion PATHa of the second path PATH2. The second port 42 may interface with the fifth interface 23 of the first processor 20 to transmit and/or receive the second type of DATA2 and control signals CK/CKb, CMDb, ADDb, a second interrupt signal INTb, and a second check signal CHb for input/output of the second type of DATA2 through the second portion PATHb of the second path PATH2. In FIGS. 7 and 8, one dedicated memory bank A-Bank for the first port 41, two dedicated memory banks C-Bank and D-Bank for the second port 42, and one shared memory bank B-Bank are illustrated for clarity of the description, but the technical ideas of the present invention are not restricted by the number of dedicated memory banks and/or share memory banks.

The multi-port memory device 40 may also include a first selection circuit 44 multiplexing the address ADDa, a second selection circuit 45 multiplexing the address ADDb, and a third selection circuit 46. The third selection circuit 46 may multiplex the address ADDa input from the first selection circuit 44 and the address ADDb input from the second selection circuit 45. Each of the selection circuits 44, 45, and 46 may be implemented by a multiplexer (MUX). A selection signal for controlling the operation of each selection circuit 44, 45, or 46 may be generated by a functional block using bank selection address out of the CMDa and the CMDb. In addition, the multi-port memory device 40 may include a write circuit (not shown) for writing data to one of a plurality of banks, a read circuit (not shown) for reading data from one of the plurality of banks, and a control circuit (not shown) for controlling the operation of the write circuit and the operation of the read circuit.

As illustrated in FIGS. 7 and 8, the multi-port memory device 40 may include internal registers, which may be 2 KB corresponding to a single row size. When a row address of a region of the shared memory bank B-BANK (e.g., ADDa=ADDb=Ox 1FFF800h˜Ox 1FFFFFh) is input to the multi-port memory device 40, the region in the shared memory bank B-Bank may be disabled and the internal registers may be enabled.

The internal registers may include a semaphore register 51, mail box registers 52 and 53, and check registers 54 and 55. The internal registers may further include a reserved register RVD. The internal registers may include information to solve a confliction situation when multiple processors, e.g., the first processor 20 and the second processor 30, simultaneously access the shared memory bank B-Bank and support permission of access authority and data transmission between the first port 41 and the second port 42.

The semaphore register 51 may stores a bit indicating a port, e.g., the first port 41 or the second port 42, has the access authority over the shared memory bank B-Bank. For instance, a value “1” of the semaphore register 51 may indicate that the first port 41 has the access authority over the shared memory bank B-Bank and a value of “0” of the semaphore register 51 may indicate that the second port 42 has the access authority over the shared memory bank B-Bank, and vice versa. The value of the semaphore register 51 can be written only by a port having the access authority. The semaphore register 51 may be a 1-bit register or a 2-bit register, but the present invention is not restricted to the current embodiments. When the semaphore register 51 is a 2-bit register, the value of the semaphore register 51 may be set to “10” or “01”.

The mail box registers 52 and 53 may be used to transmit messages (e.g., the position and size of write or read data and a command) or real short data. For instance, to transmit a message from the first port 41 to the second port 42, a mail box AB can be used by the first port 41 to write and used by the second port 42 only to read. Contrarily, to transmit a message from the second port 42 to the first port 41, a mail box BA can be used by the second port 42 to write and used by the first port 41 only to read.

The mail box AB may control the second interrupt signal INTb. For instance, a write command WR to the mail box AB may activate the second interrupt signal INTb and a read command RD to the mail box AB may deactivate the second interrupt signal INTb. In the same manner, the mail box BA may control the first interrupt signal INTa. For instance, a write command WR to the mail box BA may activate the first interrupt signal INTa and a read command RD to the mail box BA may deactivate the first interrupt signal INTa. Activation of each interrupt signal may indicate transition to a low level and deactivation of each interrupt signal may indicate transition to a high level. Vice versa is possible in other embodiments of the present invention.

A value of the check signal of each of the check registers 54 and 55 may indicate whether a message written to the mail box 52 or 53 has been read by an opposite port. The value of each check register 54 or 55 may be automatically changed according to a read/write command output from the mail box 52 or 53. For instance, when the first port 41 outputs a write command to the mail box AB, the value of the check register 54, i.e., check AB may be set to “1”. When the second port 42 outputs a read command to the mail box AB, the value of the check register 54 may be set to “0”. Vice versa is possible in other embodiments of the present invention.

A case where the access authority over the shared memory bank B-Bank is transferred from the second port 42 to the first port 41 will be described step by step with reference to FIGS. 5, 7, and 8. When the value of the semaphore register 51 is set to “0”, the first processor 20 can access the shared memory bank B-Bank as well as the dedicated memory banks C-Bank and D-Bank using the second port 42, while the second processor 30 can access the dedicated memory bank A-Bank but cannot access the shared memory bank B-Bank. As illustrated in FIG. 7, the address ADDb is multiplexed by the second selection circuit 45 to be used by the first processor 20 to access one of the two dedicated memory banks C-Bank and D-Bank and is multiplexed by the second and third selection circuits 45 and 46 to be used to access the shared memory bank B-Bank.

In the first step, the second processor 30, specifically, the main controller 39 in FIG. 6 reads the value (e.g., “0”) of the semaphore register 51 via the first port 41 to check the access authority.

In the second step, the second processor 30 writes a message requesting to transfer the access authority to the mail box register 52, i.e., the mail box AB via the first port 41. Then, the second interrupt signal INTb is activated to inform the first processor 20 that a message has been written to the mail box AB. In addition, when the second processor 30 outputs a write command to the mail box AB, the second check signal CHb of the check register 54, i.e., the check AB is set to “1”. The phase of the second interrupt signal INTb may be the same as or opposite to the phase of the value CHb of the check AB.

In the third step, the first processor 20 reads the message written to the mail box AB via the second port 42 in response to the activated second interrupt signal INTb. Then, the second interrupt signal INTb is deactivated and the second check signal CHb of the check AB is automatically changed to “0”.

In the fourth step, the first processor 20 changes the value of the semaphore register 51 from “0” to “1” via the second port 42. The first processor 20 writes a message indicating that the value of the semaphore register 51 has been changed from “0” to “1” to the mail box register 53, i.e., the mail box BA. Then, the first interrupt signal INTa is activated and the first check signal CHa of the check register 55, i.e., the check BA is set to “1”. In response to the activated first interrupt signal INTa, the second processor 30 reads the message written to the mail box BA. Then, the first interrupt signal INTa is deactivated and the first check signal CHa of the check BA is set to “0”.

In the fifth step, the second processor 30 reads the value of the semaphore register 51 via the first port 41 and confirms that the access authority over the shared memory bank B-Bank has been transferred. Accordingly, the address ADDa output from the second processor 30 and input via the first port 41 is multiplexed by the first and third selection circuits 44 and 46 to access the shared memory bank B-Bank. Therefore, the second processor 30 can access the shared memory bank B-Bank via the first port 41.

A procedure where the access authority over the shared memory bank B-Bank is transferred from the first port 41 to the second port 42 will be understood referring to the first through fifth steps described above.

Referring to FIGS. 5 and 6, the interrupt signal INTb or INTa and the check signal

CHb or CHa of the check register 54 or 55 are transmitted to the processor 20 or 30, but only the interrupt signal INTb or INTa may be transmitted to the processor 20 or 30 in other embodiments of the present invention.

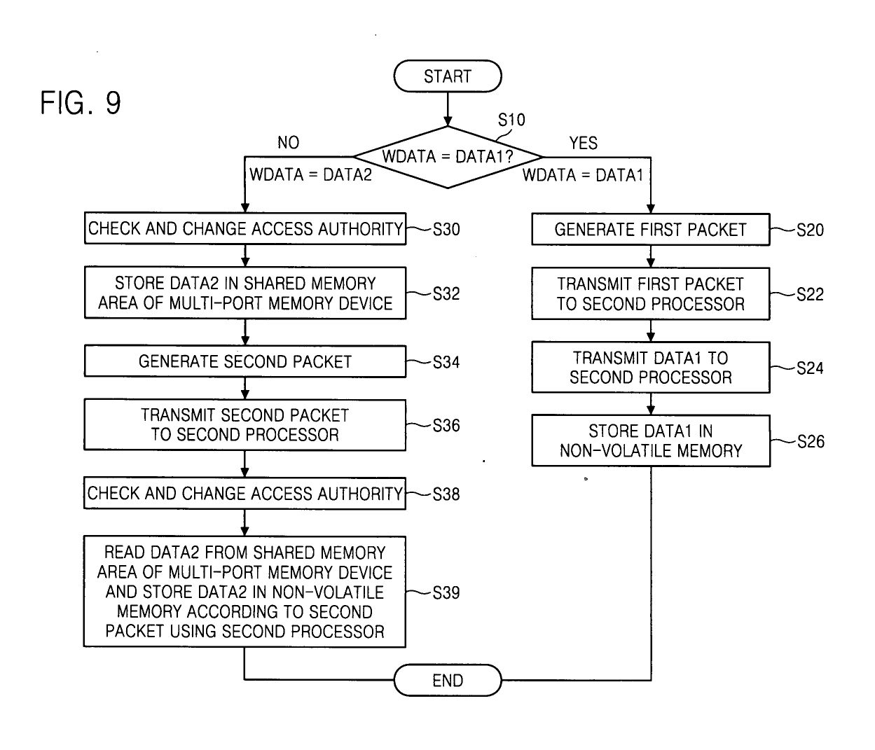

FIG. 9 is a flowchart of the data write operation of the data processing system 10 illustrated in FIG. 5. The write operation of the data processing system 10 will be described with reference to FIGS. 5 through 9. It is assumed that the value of the semaphore register 51 is set to “1”. Accordingly, the access authority over the shared memory bank B-Bank is possessed by the second processor 30.

The first processor 20 may receive write data WDATA to be written to the non-volatile memory 50 and determine whether the write data WDATA is the first type of DATA1 of the first type or the second type of DATA2 of the second type at a file system level, in operation S10. This determination may be based on the size of the data as described in detail above. When the write data WDATA is determined as the first type of DATA1, the first processor 20 may generate the first packet PAC1 in operation S20. The first packet PAC1 may include a write command, information indicating a position (e.g., an address) to which the write data WDATA, the first type of data DATA1, will be written in the non-volatile memory 50, and information indicating a size of the write data WDATA.

The first processor 20 may transmit the first packet PAC1 to the second processor 30 through the first path PATH1 in operation S22. The first processor 20 may transmit the first type of DATA1 to the second processor 30 through the first path PATH1 in operation S24. According to other embodiments of the present invention, the first type of DATA1 may be included in the first packet PAC1. According to further embodiments of the present invention, the first type of DATA1 may be transmitted to the second processor 30 separately from the first packet PAC1 in operation S22.

The main controller 39 of the second processor 30 receives the first packet PAC1 through the first path PATH1 and the bridge 38 and decodes the first packet PAC1. According to a decoding result, the main controller 39 of the second processor 30 outputs control signals for controlling the operation of the third interface 37 to the third interface 37. The third interface 37 may write the first type of DATA1 input through the first path PATH1 into the non-volatile memory 50 in response to the control signals output from the main controller 39 in operation S26.

On the other hand, if the write data WDATA is determined by the first processor 20 to be the second type of DATA2 of the second type in operation S10, the first processor 20 checks the access authority over the shared memory bank B-Bank of the multi-port memory device 40 via the second port 42 in operation S30. In detail, the first processor 20 reads the value “1” of the semaphore register 51 via the second port 42. The first processor 20 writes a message requesting to transfer the access authority to the mail box register 53, i.e., the mail box BA via the second port 42. Then, the activated first interrupt signal INTa is transmitted to the main controller 39 of the second processor 30 and the first check signal CHa of the check register 55, i.e., the check BA is set to “1”. The second processor 30 reads the message written to the mail box BA in response to the activated first interrupt signal INTa. Then, the first interrupt signal INTa is deactivated and the first check signal CHa of the check BA is changed to “0”. The second processor 30 changes the value of the semaphore register 51 from “1” to “0” via the first port 41 in response to the message read from the mail box BA. The second processor 30 writes a message indicating that the value of the semaphore register 51 is changed from “1” to “0” to the mail box register 52, i.e., the mail box AB. Then, the activated second interrupt signal INTb is transmitted to the first processor 20 via the second port 42 and the second check signal CHb of the check register 54, i.e., the check AB is changed to “1”. The first processor 20 reads the message written to the mail box AB. Then, the second interrupt signal INTb is deactivated and the second check signal CHb of the check AB is changed to “0”. Accordingly, the first processor 20 checks the value of the semaphore register 51 and finds out that the value of the semaphore register 51 has been changed to “0” in operation S30.

The first processor 20 that has acquired the access authority over the shared memory bank B-Bank writes the second type of DATA2 to the shared memory bank B-Bank through the second portion PATHb of the second path PATH2 in operation S32. The write command CMDb, the write address ADDb, and the differential clock signals CK/CKb may be used to write the second type of DATA2 to the shared memory bank B-Bank.

While or after the second type of DATA2 is written to the shared memory bank B-Bank, the first processor 20 generate the second packet PAC2 in operation S34. According to some embodiments of the present invention, the multi-port memory device 40 may transmit an indication signal indicating that the second type of DATA2 has been completely written to the shared memory bank B-Bank to the first processor 20 through the second portion PATHb of the second path PATH2. At this time, the first processor 20 may generate the second packet PAC2 in response to the indication signal in operation S34. Alternatively, operation S34 may be performed before operation S32.

The first processor 20 transmits the second packet PAC2 to the second processor 30 through the first path PATH1 in operation S36. The main controller 39 of the second processor 30 decodes the second packet PAC2 input through the first path PATH1 and the bridge 38. Since the first processor 20 has the access authority over the shared memory bank B-Bank to which the second type of DATA2 has been written, the second processor 30 requests the first processor 20 to transfer the access authority over the shared memory bank B-Bank.

When the first processor 20 changes the value of the semaphore register 51 from “0” to “1” in response to the request in operation S38, the main controller 39 of the second processor 30 reads the second type of DATA2 from the shared memory bank B-Bank via the first port 41 through the first portion PATHa of the second PATH2 and writes the second type of DATA2 to the non-volatile memory 50 according to the result of decoding the second packet PAC2 in operation S39. In other words, the second processor 30 acquiring the access authority over the shared memory bank B-Bank from the first processor 20 reads the second type of DATA2 stored in the shared memory bank B-Bank of the multi-port memory device 40 via the first port 41 and stores the second type of DATA2 in the non-volatile memory 50 according to the result of decoding the second packet PAC2 in operation S39.

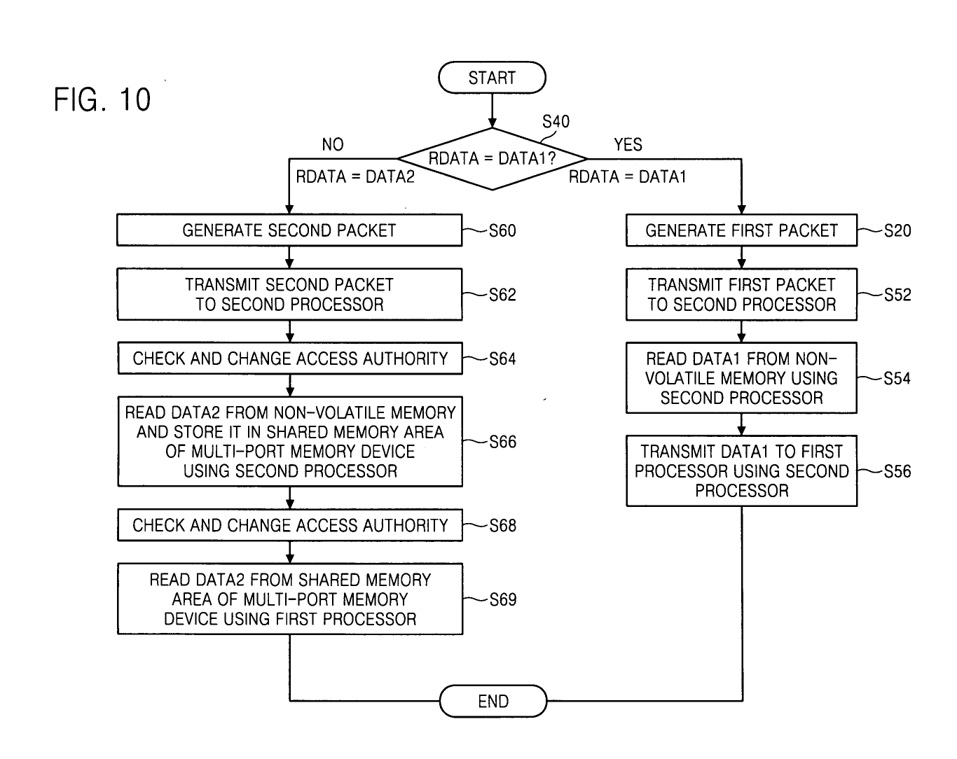

FIG. 10 is a flowchart of the data read operation of the data processing system 10 illustrated in FIG. 5. The read operation of the data processing system 10 will be described with reference to FIGS. 5 through 8 and FIG. 10. It is assumed that the value of the semaphore register 51 is set to “0” and the access authority over the shared memory bank B-Bank is possessed by the first processor 20.

The first processor 20 determines whether read data RDATA to be read is the first type of DATA1 of the first type or the second type of DATA2 of the second type at a file system level in operation S40. When the read data RDATA is determined to be the first type of DATA1, the first processor 20 generates the first packet PAC1 in operation S20. The first packet PAC1 includes a read command, information indicating a position from which the read data RDATA will be read in the non-volatile memory 50, and information indicating the size of the read data RDATA.

The first processor 20 transmits the first packet PAC1 to the second processor 30 through the first path PATH1 in operation S52. The main controller 39 of the second processor 30 decodes the first packet PAC1 received through the first path PATH1 and the bridge 38. In response to a decoding result, the third interface 37 of the second processor 30 reads the first type of DATA1 from the non-volatile memory 50 in operation S54. In other words, the non-volatile memory 50 reads the first type of DATA1 in response to the read command CMD and the read address ADD output from the third interface 37 and transmits the first type of DATA1 to the second processor 30. The first interface 33 of the second processor 30 transmits the first type of DATA1 to the first processor 20 through the first path PATH1 under the control of or independently of the main controller 39 in operation S56.

On the other hand, if the read data RDATA is determined by the first processor 20 to be the second type of DATA2 of the second type in operation S40, the first processor 20 generates the second packet PAC2 in operation S60. The second packet PAC2 may include a read command, information about a position from which the second type of DATA2 will be read in the non-volatile memory 50, information about the size of the second type of DATA2, and information about a position to which the second type of DATA2 will be written in shared memory bank B-Bank. The first processor 20 transmits the second packet PAC2 to the second processor 30 through the first path PATH1 in operation S62.

The main controller 39 of the second processor 30 decodes the second packet PAC2 and outputs control signals for reading the second type of DATA2 from the non-volatile memory 50 to the third interface 37 in response to a decoding result. The third interface 37 reads the second type of DATA2 from the non-volatile memory 50 in response to the control signals including the read command CMD and the read address ADD.

According to the result of decoding the second packet PAC2, the second processor 30 requests the first processor 20 to transfer the access authority over the shared memory bank B-Bank via the mail box AB, as described with reference to FIG. 7. When the first processor 20 changes the value of the semaphore register 51 from “0” to “1” in response to the request, the second processor 30 can access the shared memory bank B-Bank through the first port 41, i.e., the first portion PATHa of the second path PATH2. In other words, the second processor 30 checks and changes the access authority over the shared memory bank B-Bank according to the result of decoding the second packet PAC2 in operation S64.

After confirming the change of the access authority over the shared memory bank B-Bank, the main controller 39 of the second processor 30 outputs control signals for writing the second type of DATA2 read from the non-volatile memory 50 to the multi-port memory device 40 to the second interface 35 according to the decoding result. Accordingly, the second interface 35 outputs control signals including the clock signal CLKa, the address ADDa, and the write command CMDa necessary for the write operation and the second type of DATA2 to the first port 41 of the multi-port memory device 40.

The first port 41 writes the second type of DATA2 to the shared memory bank B-Bank in response to the controls signals CLKa, CMDa, and ADDa output from the second interface 35. The first port 41 may write the second type of DATA2 to the shared memory bank B-Bank directly or via the first port dedicated memory bank A-Bank. As a result, the second processor 30 reads the second type of DATA2 from the non-volatile memory 50 and writes it to the shared memory bank B-Bank of the multi-port memory device 40 in operation S66. The main controller 39 of the second processor 30 may transmit an indication signal indicating that the second type of DATA2 has been completely written to the shared memory bank B-Bank to the first processor 20 through the first path PATH1.

While or after the second type of DATA2 is written to the shared memory bank B-Bank, the first processor 20 checks the access authority over the shared memory bank B-Bank and requests the transfer of the access authority over the shared memory bank B-Bank via the mail box BA in operation S68. After the second processor 30 changes the value of the semaphore register 51 from “1” to “0” via the first port 41 in operation S68, the first processor 20 reads the second type of DATA2 from the shared memory bank B-Bank via the second port 42 in operation S69.

As described above, the first processor 20 or the second processor 30 checks the access authority over the shared memory bank B-Bank before accessing the shared memory bank B-Bank and, when it is found out that the other processor 30 or 20 has the access authority, requests the other processor 30 or 20 to transfer the access authority. After the other processor 30 or 20 changes the value of the semaphore register 51 in response to the request, the first or second processor 20 or 30 can access the shared memory bank B-Bank.

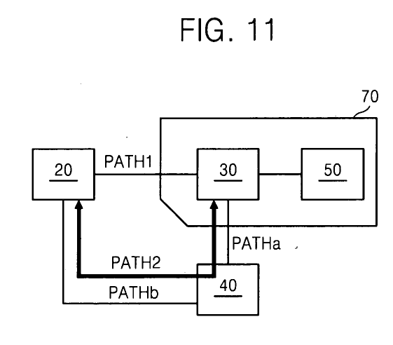

FIG. 11 is a block diagram of a data processing system including a memory card 70 according to example embodiments of the present invention. Referring to FIGS. 5 and 11, the memory card 70 includes the second processor 30 and the non-volatile memory 50. Accordingly, the first processor 20 may transmit the first packet PAC1 or the second packet PAC2 to the memory card 70 through the first path PATH1. The first processor 20 may transmit and receive the first type of DATA1 to and from the memory card 70 through the first path PATH1. The first packet PAC1, the second packet PAC2, and the first type of DATA1 transmitted through the first path PATH1 are compatible with an SD card protocol or an MMC protocol.

In addition, the first processor 20 may transmit and receive the second type of DATA2 to and from the memory card 70 using the multi-port memory device 40. In detail, the first processor 20 and the multi-port memory device 40 may form the second portion PATHb of the second path PATH2 and the multi-port memory device 40 and the memory card 70 may form the first portion PATHa of the second path PATH2. The first processor 20 and the multi-port memory device 40 may be implemented within the data processing system for communicating with the memory card 70.

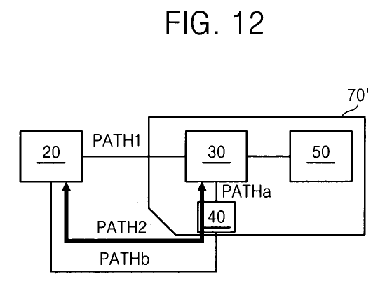

FIG. 12 is a block diagram of a data processing system including a memory card 70′ according to other embodiments of the present invention. Referring to FIGS. 5 and 12, the memory card 70′ may include the second processor 30, the multi-port memory device 40, and the non-volatile memory 50. As described above, the first processor 20 may transmit and receive the first type of DATA1 to and from the memory card 70′ through the first path PATH1 and may transmit and receive the second type of DATA2 to and from the memory card 70′ through the second path PATH2. Information including a command and an address necessary for the transceiving of the first type of DATA1 or the second type of DATA2 may be transmitted from the first processor 20 to the memory card 70′ through the first path PATH1.

Although the memory cards 70 and 70′ are illustrated in FIGS. 11 and 12, an SSD according to example embodiments of the present invention may include the second processor 30 and the non-volatile memory 50 as illustrated in FIG. 11 or may include the second processor 30, the multi-port memory device 40, and the non-volatile memory 50 as illustrated in FIG. 12.

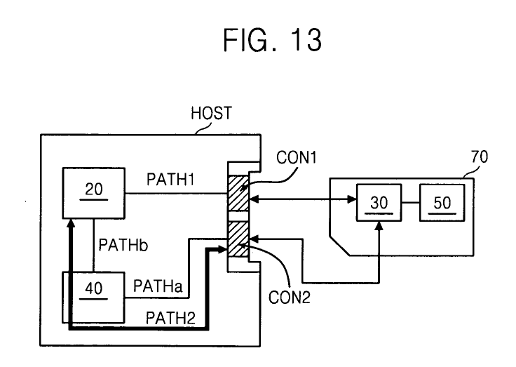

FIG. 13 is a block diagram of a data processing system including a host and the memory card 70 illustrated in FIG. 11. Referring to FIG. 13, the host includes the first processor 20, the multi-port memory device 40, and a slot. The slot may include a first connector CON1 connected with the first processor 20 and a second connector CON2 connected with the multi-port memory device 40. The first controller 33 (FIG. 6) of the second processor 30 of the memory card 70 may be connected with the first connector CON1 and the second controller 35 (FIG. 6) of the second processor 30 may be connected with the second connector CON2. The first and second connectors CON1 and CON2 may be referred to as ports.

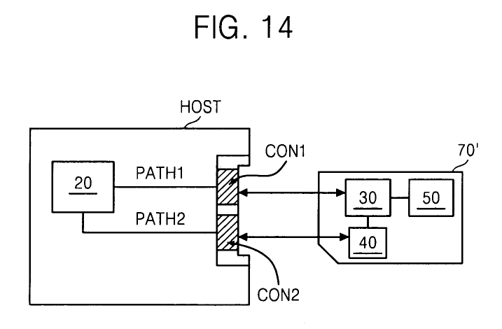

FIG. 14 is a block diagram of a data processing system including a host and the memory card 70′ illustrated in FIG. 12. Referring to FIG. 14, the host may include the first processor 20. The first processor 20 may be connected with a first connector CON1 to form the first path PATH1 and may be connected with a second connector CON2 to forth the second path PATH2.

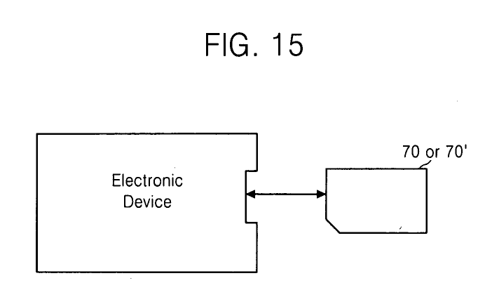

FIG. 15 is a block diagram of an electronic system including the memory card 70 or 70′ illustrated in FIG. 11 or 12. Referring to FIG. 15, the memory card 70 or 70′ may be connected with an electronic device such as a video camera, a digital television (TV), an Internet protocol TV (IPTV), an MP3 player, an MP4 player, an electronic game unit, an electronic instrument, a portable communication terminal, a personal computer (PC), a personal digital assistant (PDA), a portable multimedia player (PMP), a voice recorder, or a memory card reader. Accordingly, the electronic device such as a video camera, a digital TV, an IPTV, an MP3 player, an MP4 player, an electronic game unit, an electronic instrument, a portable communication terminal, a PC, a PDA, a PMP, a voice recorder, or a memory card reader may have the same structure as the host illustrated in FIG. 13 or 14.

According to example embodiments of the present invention, a data processing system can process data having different sizes using different paths, thereby remarkably increasing a data processing speed.

While the present invention has been particularly shown and described with reference to exemplary embodiments thereof, it will be understood by those of ordinary skill in the art that various changes in forms and details may be made therein without departing from the spirit and scope of the present invention as defined by the following claims.

What is claimed is:

1. A data processing system comprising:
a non-volatile memory; and
a processor configured to control an operation of the non-volatile memory,
wherein the processor is configured to transmit and receive a first type of data and first control signals associated with the first type of data via a first path, and
the processor is configured to transmit and receive a second type of data via a second path different from the first path and to transmit second control signals associated with the second type of data via the first path, and
the processor configured to at least one of (i) read the first and second types of data from the non-volatile memory, and (ii) write the first and second types of data to the non-volatile memory.

2. The data processing system of claim 1, further comprising:
a data storage device connected between the processor and the non-volatile memory to process the second data.

3. The data processing system of claim 1, further comprising:
a multi-port memory device having a first port, a second port and a memory area, the memory area being accessible via the first port connected with the processor and the second port connected to the non-volatile memory.

4. The data processing system of claim 1, further comprising:
a multi-port memory device comprising a first port, a second port, a first dedicated memory area accessible via the first port connected with the processor, a second dedicated memory area accessible via the second port connected with the non-volatile memory, and a shared memory area, which is accessible via the first port or the second port according to an access authority.

5. The data processing system of claim 4, wherein
the multi-port memory device is in the second path and is configured to at least one of transmit the second type of data to the processor and receive the second type of data from the processor.

6. The data processing system of claim 1, wherein a size of the first type of data is less than a size of the second type of data.

7. The data processing system of claim 1, wherein a data rate of the first type of data is lower than a data rate of the second type of data.

8. The data processing system of claim 1, wherein the first type of data is code data and the second data type of is user data.

9. The data processing system of claim 1, wherein the first type of data is page size data and the second type of data is user data having a larger size than a page size of the page size data.

10. The data processing system of claim 1, wherein the data processing system is a memory card or a solid state drive.

11. The data processing system of claim 1, wherein the first path comprises a card interface or a serial advanced technology architecture (SATA) interface and the second path comprises a dynamic random access memory (DRAM) interface or a static random access memory (SRAM) interface.

12. The data processing system of claim 1, wherein the first path comprises a non-dynamic random access memory (DRAM) interface and the second path comprises a DRAM interface.

13. The data processing system of claim 1, wherein the first path comprises a non-static random access memory (SRAM) interface and the second path comprises an SRAM interface.

14. A data processing method of a data processing system comprising:
writing code data, input from an outside through a first path in a code data processing mode, to a non-volatile memory using a processor; and
writing user data, input from the outside through a second path different from the first path in a user data processing mode, to the non-volatile memory using the processor.

15. The data processing method of claim 14, further comprising:
receiving a write command and a write address for the code data through the first path using the processor, before writing the code data to the non-volatile memory; and
receiving a write command and a write address for the user data through the first path using the processor, before writing the user data to the non-volatile memory.

16. The data processing method of claim 14, wherein a size of the code data is less than a size of the user data.

17. The data processing method of claim 14, wherein a data rate of the code data is lower than a data rate of the user data.

18. A data processing method, comprising:
determining a type of an access data at a processor; and
accessing a non-volatile memory through a first path or through a second path different from the first path depending on a determination result.

19. The data processing method of claim 18, wherein the accessing the non-volatile memory comprises:
when the access data is determined to be first data, accessing the non-volatile memory through the first path, through which a command and an address for accessing the first data are transmitted, using the processor; and
when the access data is determined to be second data having a larger size than the first data, accessing the non-volatile memory via a data storage device, which is located on the second path, using the processor.

20. A data processing system, comprising:
a data storage device configured to store input data; and
a first processor configured to determine a type of access data and transmit the access data to a second processor or the data storage device according to a determination result,
wherein the second processor is configured to write the access data output from the first processor or data output from the data storage device to a non-volatile memory.

21. The data processing system of claim 20, wherein the first processor is configured to determine the type of the access data according to a size of the access data.

22. The data processing system of claim 20, wherein the first processor is configured to transmit the access data to the second processor when the access data is code data and is configured to transmit the access data to the data storage device as the input data when the access data is mass data.

23. A data processing system, comprising:
a first port and a second port;
a first processor configured to be connected with the first port and to determine whether write data is first type of data or second type of data; and
a data storage device connected between the first processor and the second port,
wherein when the write data is the first type of data, the first processor is configured to transmit the first type of data, a first command and a first, address for writing the first type of data to the first port,
wherein when the write data is the second data, the first processor is configured to transmit a second command and, a second address for writing the second type of data to the first port, and
wherein the data storage device is configured to receive and process the second type of data and is configured to transmit the processed second type of data to the second port.

24. The data processing system of claim 23, wherein the first processor is configured to determine the write data to be the first type of data or the second type of data according to a size of the write data.

25. The data processing system of claim 23, further comprising:
a second processor connected with the first port and the second port, the second processor is configured to write the first type of data input via the first port to a non-volatile memory according to the first command and the first address input via the first port and is configured to write the second type of data input via the second port to the non-volatile memory according to the second command and the second address input via the first port.

26. A data processing method in a data processing system including a first port, a second port, a processor connected with the first port, and a data storage device connected between the processor and the second port, the data processing method comprising:
determining whether write data is first type of data or second type of data using the processor;
if the write data is the first type of data, transmitting the first type of data, a first command, and a first address for writing the first type of data to the first port using the processor;
if the write data is the second type of data, transmitting a second command, a second address for writing the second type of data to the first port and transmitting the second type of data to the data storage device using the first processor; and
processing the received second type of data and transmitting the processed second type of data to the second port using the data storage device.

27. The data processing method of claim 26, wherein the determining whether the write data is the first type of data or the second type of data comprises determining the write data to be the first type of data or the second type of data according to a size of the write data.

28. A data processing system, comprising:
a first device;
a second device including a memory to store a first type of data and a second type of data;
a first path between the first device and the second device, the first path configured to interface the first type of data, a first packet associated with the first type of data and a second packet associated with the second type of data; and
a second path different from the first path between the first device and the second device, the second path configured to interface the second type of data.
